(19) United States
(12) Patent Application Publication
(10) Pub. No.: US 2022/0074738 A1
(43) Pub. Date: Mar. 10, 2022

(54) THREE DIMENSIONAL IMAGING

(71) Applicant: Hewlett-Packard Development Company, L.P., Spring, TX (US)

(72) Inventors: Stephen Bernard Pollard, Bristol (GB); Fraser John Dickin, Bristol (GB); Guy de Warrenne Bruce Adams, Bristol (GB)

(73) Assignee: Hewlett-Packard Development Company, L.P., Spring, TX (US)

(21) Appl. No.: 17/414,748

(22) PCT Filed: Apr. 11, 2019
(86) PCT No.: PCT/US2019/026910

§ 371 Date: Jun. 16, 2021

(51) Int. Cl. G01B 11/25; B33Y 30/00

(52) U.S. Cl. CPC G01B 11/2518; G01B 11/2536; B33Y 50/02; B33Y 30/00; G01B 11/2545

(57) ABSTRACT

Disclosed are a 3D scanner, an additive manufacturing system and an apparatus and method for identifying features of a 3D object manufactured in such a system. An apparatus comprises an optical projection assembly comprising a light source and an optical grating, for illuminating an object with first and second light patterns having different spatial frequencies, wherein the optical projection assembly provides a first light pattern in a first configuration of the optical projection assembly and provides a second light pattern in a second configuration of the optical projection assembly. An image capturing apparatus is used to capture images corresponding to reflections of the first and second light patterns from the illuminated object, and a processing unit is used to identify, from the captured reflections of the first and second light patterns, the effects of distortions in the reflected light patterns corresponding to features of the illuminated object.

### BACKGROUND

Additive manufacturing systems are used to manufacture three-dimensional (3D) objects, for example by utilizing a mechanism for successively delivering a material to a print bed to build up a 3D object. The additive manufacturing process may, for example, include selectively delivering coalescing or fusing agents onto a layer of build material to build the 3D object in successive layers. 3D printers may use such a mechanism to additively manufacture 3D objects.

### BRIEF DESCRIPTION OF THE DRAWINGS

Various features of exemplary apparatus, systems and methods are described below, by way of example only, with reference to the accompanying drawings in which:

FIG. 1 is a schematic representation of a system for identifying and measuring surface features of an object according to an example;

FIG. 2 shows four example phase-shifted images of a simple object;

FIG. 3 shows four phase-shifted images of the same object as FIG. 2, as captured by each of two cameras, for two different spatial frequency patterns;

FIG. 4 represents recovered depth-dependent phase information from the two different cameras for two different spatial-frequency patterns, according to an example;

FIG. 5 provides an overview of a method according to an example;

FIG. 6A is a representation of points in dual phase space;

FIG. 6B represents a process for finding closest points in dual phase space, according to an example;

FIG. 7 is a schematic representation of a second example apparatus;

FIG. 8 is a schematic representation of a third example apparatus; and

FIG. 9 is a schematic representation of a fourth example apparatus.

### DETAILED DESCRIPTION

The present disclosure relates to an optical projection assembly for a three-dimensional (3D) imaging and measurement apparatus, and a 3D scanning and measurement process, which is suitable for use in a 3D print process such as in an additive manufacturing system. Although some manufacturing systems include equipment to monitor build quality, current solutions are non-optimal for 3D printers.

Three-dimensional images of 3D objects can be generated by projecting structured light patterns onto an object and capturing images of the reflected patterns using an appropriate camera. Distortions in the reflected patterns are indicative of different heights and depths of the illuminated object's surface features. Local distortions in the reflected patterns that are indicative of surface features, and triangulation between the camera and the projector or between multiple cameras, allows depth information to be recovered.

An example scanner that uses a digital light processing (DLP) projector can project sine wave patterns onto an object in order to measure the pattern's phase in the captured image. However, DLP projectors are non-optimal for monitoring 3D printed objects, firstly because of the size, cost and power consumption of available DLP projectors. Inaccuracies can arise due to non-linearity and “drifting” with increasing temperature of control electronics, and large cooling fans may be used to mitigate the effects of heating. A further problem is that phase wrapping limits the range of depths that can be measured without ambiguity, and this may require many patterns to be projected to resolve the ambiguity. These problems can be mitigated by using a new optical projection assembly that is capable of projecting a plurality of light patterns with different spatial frequency.

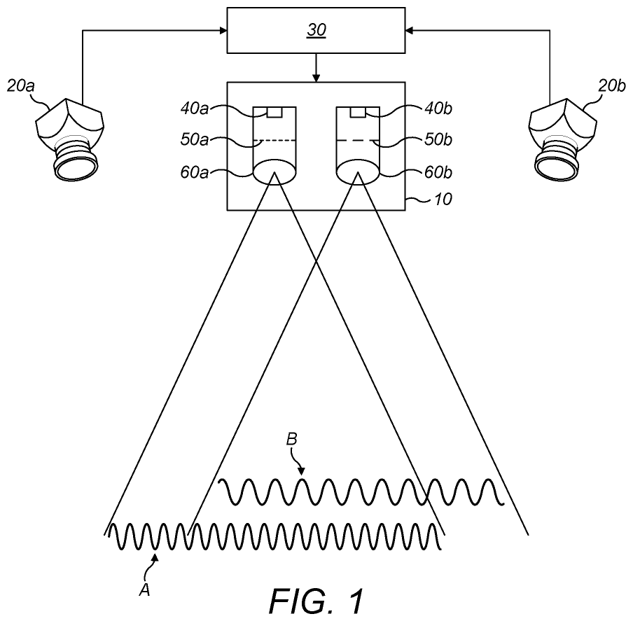

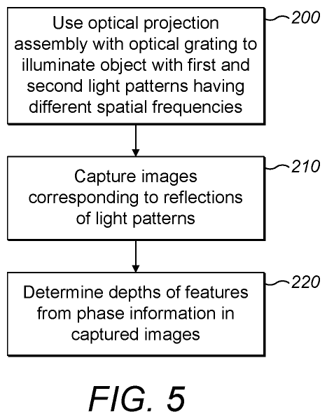

A first example apparatus that is suitable for identifying features of a three dimensional object is shown schematically in FIG. 1, for carrying out the method of FIG. 5. The apparatus includes an optical projection assembly 10 for illuminating 200 an object with first and second light patterns A, B having different spatial frequencies, and an image capturing apparatus including a pair of cameras 20a, 20b for capturing 210 images corresponding to reflections of the first and second light patterns from the illuminated object. The apparatus also includes a processing unit 30 for determining 220 the depths of features of the illuminated object, from the captured reflections of the first and second light patterns, using the effects of phase variations in the reflected light patterns corresponding to features of the illuminated object.

A number of examples of apparatus for carrying out the method of FIG. 5 are described below, in which the optical projection assembly 10 includes at least one light source 40a, 40b (which may emit visible or non-visible light) and at least one optical grating 50a, 50b for illuminating 200 an object with first and second light patterns A, B having different spatial frequencies. In one example, a plurality of optical gratings 50a, 50b is provided with different spacings between their optical transmission features to project light patterns with different spatial frequencies. This stereo system including two cameras 20a, 20b and a pair of fixed pattern generators of different spatial frequency is described in more detail below. The use of a stereo system in conjunction with fixed pattern generators is advantageous because depth recovery is independent of the various non-linearities of such systems. For matt reflectance surfaces, the distorted phase information provides a fixed, viewpoint-invariant, signal on the object that can be matched in the stereo system. Therefore, even though the pattern generators have different optical centres, the combination of phase shift signals reflected from the object surface will be fixed and experienced equally in each camera.

In one example, each optical grating 50a is used with a plurality of light sources including 3 or 4 light source positions equidistant from the grating, to project 200 multiple phase-shifted patterns for each of two or more spatial frequency patterns A, B. A light source array may include 3 or 4 LED light sources 40 in a linear arrangement, with each LED equidistant from the grating, in order to project the phase-shifted patterns, or a light source array may comprise a two dimensional array including 3 or 4 LEDs at each of two different distances from the grating 50a. In another example, one or more LEDs may be movable into different positions to achieve different source positions. Another example combines an optical grating with an adjustable optical focussing element 60, to change the spatial frequency of the projected pattern.

Each of the above-described options enables projection of light patterns with different spatial frequencies from either a single grating 50 (if using light sources 40 at different distances, or an adjustable defocussing element 60 such as a defocussing lens) or from each of two or more optical gratings 50a, 50b of the optical projection assembly. In each of these alternative options, the optical projection assembly 10 provides a first light pattern from a first optical projection configuration, comprising a defocussing element 60 and an optical grating 50 and a light source 40, and provides a second light pattern from a second optical projection configuration. The first and second light patterns A, B have different spatial frequencies from each other, but each pattern has an almost constant frequency.

In one example, the optical projection assembly includes two or more Ronchi gratings 50a, 50b, which are two digital masks that have different spacing between the light transmission features of the respective masks (e.g. masks etched on glass) so as to generate structured light patterns with different spatial frequency when the gratings are illuminated by one or more respective light sources 40a, 40b. Each grating generates a square wave when illuminated, and a defocussing element (such as a defocussing lens or other defocussing optics) then modifies the square wave to generate 200 a periodic, continuously-varying light pattern (e.g. a pattern that roughly approximates a sine wave; but a precise sine wave pattern is not required in a dual camera system). A pair of cameras 20a,20b capture 210 reflections of the light patterns from two different perspectives. The reflected light patterns each include phase distortions indicative of the different depths of surface features of the illuminated object, and so measurements of the phase distortions in the plurality of captured images can be used to calculate 220 depths and therefore identify and optically measure the illuminated object's features. This is done using triangulation, based on identifying the same points in each image based on the phase signal and other stereo constraints.

Thus, a simple LED or array of LEDs can be used in combination with two or more optical masks such as Ronchi gratings to generate two or more light patterns with different spatial frequencies (each being a regular periodic pattern with continuously varying amplitude). Using a pair of gratings provides an acceptable measurement depth range at low cost, by increasing the depth range before phase wrapping occurs for the combination of patterns. This is explained below.

For each pattern frequency, a plurality of phase-shifted patterns is projected onto the object to be measured, either by moving the illumination source or the grating itself, or by switching between a plurality of illumination sources that are arranged in an array equidistant from a grating. Thus, in an apparatus that includes two Ronchi gratings, a plurality of phase shifted first patterns (with a first spatial frequency) and a plurality of phase-shifted second patterns (with a second spatial frequency) is achieved by either moving the individual gratings or by switching or moving the illumination sources. For example, six or eight image pairs are used—i.e. three or four phase-shifted patterns for each of the two different pattern frequencies of the two Ronchi gratings.

Using a pair of patterns with different spatial frequency increases the period over which the joint signal (combination of measured phases) wraps around, providing an unambiguous signal over a much larger range of disparity (difference in camera projection) and hence a larger depth range for illuminated objects, when compared to either of the constituent phase patterns. Although this dual frequency phase shift solution has potential applicability for projection assemblies including DLPs, it has additional advantages when the set of phase-shifted patterns is provided by lower-cost fixed pattern generators, such as projectors using Ronchi gratings, which can be illuminated by LEDs and combined with defocussing optics to provide the set of phase-shifted patterns. This is partly because the dual frequency and dual camera solution is independent of non-linearities of the projector, removing the need for the projected patterns to be precise sine waves. The solution enables matching of the phase signal between two views, such that it is not necessary to infer the geometry of the illuminated object directly from the value of the phase measurements. This achieves independence from non-linearities in the projection, allows a departure from pure sine waves and allows the use of separate optical assemblies and movement/switching of LEDs.

The dual-frequency phase-measurement solution described above overcomes several problems with systems that rely on DLP projectors. Fixed pattern gratings are inexpensive and a projection assembly as described above can be implemented as a low-cost, light-weight component of a 3D scanner that reduces the overall size of the 3D scanner compared with bulky DLP projectors. By increasing the portability of the 3D scanner, the above-described projection assembly facilitates the use of small robotic arms to carry the 3D scanner for automated scans. By drastically reducing power consumption, the above-described projection assembly facilitates the production of hand-held, battery operated and/or wireless 3D scanners.

Example implementations that include multiple LEDs 40 for illuminating each of a pair of optical gratings 50a, 50b, the apparatus including the optical projection assembly 10, cameras 20a, 20b and processing unit 30 can be constructed with no moving parts, with multiple phase-shifted images captured either simultaneously (using differentiated light sources and filtering of the captured images) or in quick succession (if the light sources of an array are switched sequentially). Alternative examples use movable gratings or movable light sources.

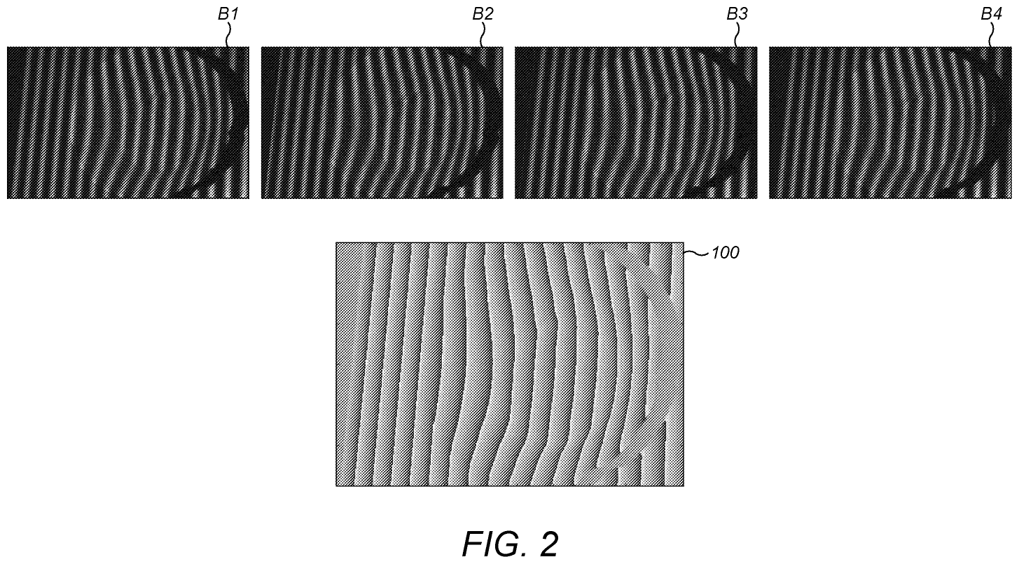

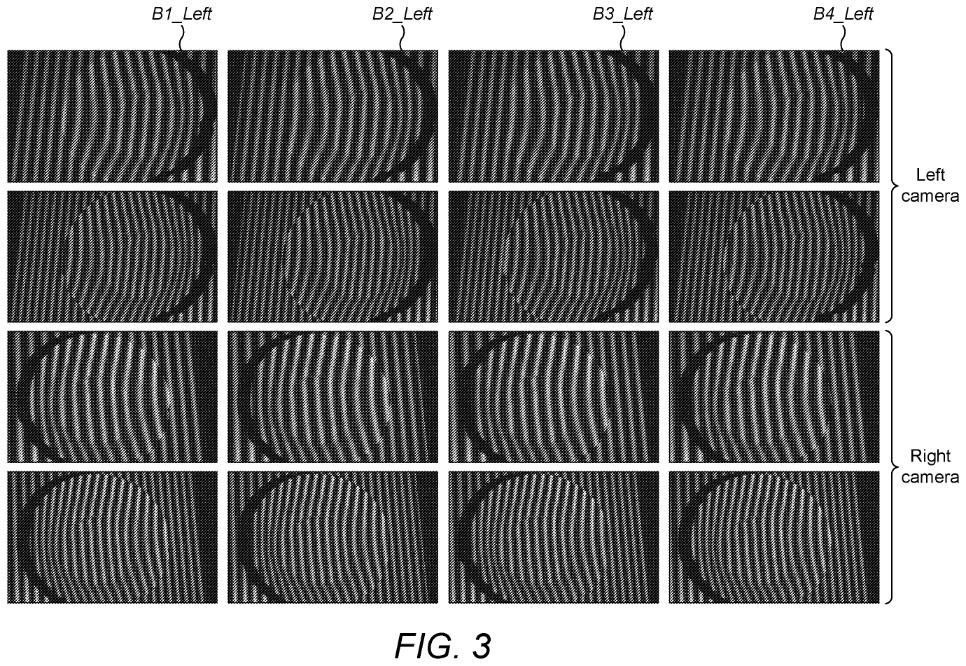

Example captured images for such a system are shown in FIGS. 2 and 3. Referring to FIG. 2, four images B1, B2, B3 and B4 of a simple bowl-shaped object are representative of images captured using a single Ronchi Grating illuminated from 4 different source positions. Each phase shifted image B1, B2, B3, B4 is recovered using 4 approximate sine wave projections with phase successively increasing by approximately π/2.

When a structured light pattern is projected onto a 3D object using an optical grating and defocussing optics to approximate a sine wave, and the reflected image is captured by a camera, the intensity, I, of the reflected image of a pattern n at each location c can be expressed as:

Iₙ^{c}=A^{c}+B^{c} cos(ϕ+δₙ)

Where A^{c} is ambient light intensity, B^{c} is the surface reflectance, ϕ is the unknown depth-dependent phase and δₙ is the pattern phase for the phase-shifted pattern.

For a solution with N patterns (n=0 to n=N−1), the depth dependent phase can be expressed as:

$$ϕ = arctan \frac{{\sum }_{n = 0}^{N - 1} {I}_{n}^{c} sin ( {δ}_{n} )}{{\sum }_{n = 0}^{N - 1} {I}_{n}^{c} cos ( {δ}_{n} ) }$$

Where there are four phase-shifted patterns, with each phase shifted by approximately π/2 and the pattern repeats every 2π, the depth dependent phase can be calculated as:

$$ϕ = arctan \frac{{I}_{4}^{c} - {I}_{2}^{c}}{{I}_{1}^{c} - {I}_{3}^{c}}$$

According to an example, a direct mapping between the recovered phase ϕ and the 3-D coordinates of the object can be derived.

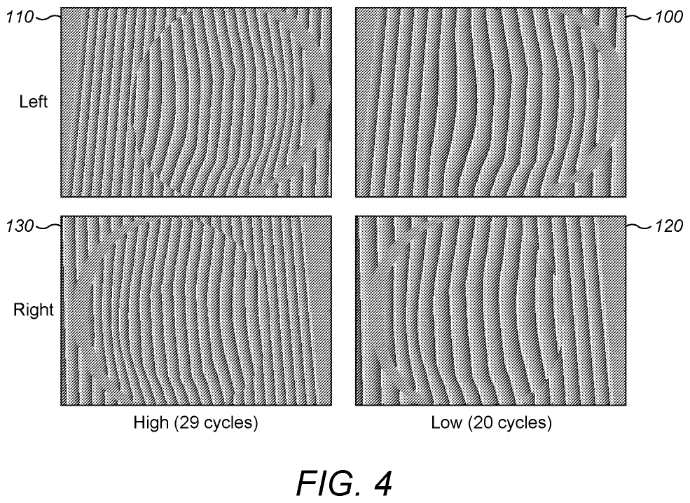

An example of images captured using projected sine wave patterns at 2 different frequencies and using left and right cameras is shown in FIG. 3. From each set of 4 images phase-shifted in the horizontal direction (such as images B1_Left, B2_Left, B3_Left and B4_Left captured by a single camera using a single pattern frequency, but using 4 different light source positions to produce images), it is possible to reconstruct a depth-dependent phase estimate 100, 110, 120, 130 as shown in FIG. 4.

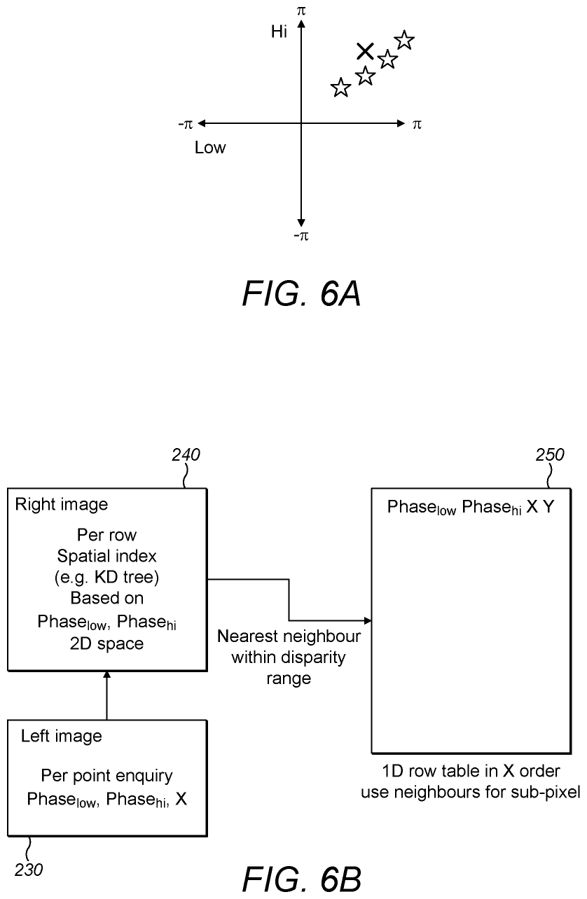

FIG. 4 shows low frequency phase estimates 100, 120 and high frequency phase estimates 110, 130 for the left and right cameras. These provided false colour images that range in value between ±π and exhibit obvious phase wrapping at close to the same frequency as the original phase images shown in FIG. 3. The range of possible disparity between the left and right images is large in comparison to the repeating phase signal making it difficult to uniquely identify corresponding points in the 2 images sharing the same phase value. FIG. 6A illustrates the concept of a 2-dimensional dual frequency phase space, where the horizontal axis represents the low frequency phase and the vertical axis the high frequency version. Also illustrated in this space is a single dual phase value recovered from the left image represented by a cross. Candidate corresponding points in the right images will be constrained to lie along a single 2D line (the epipolar line) and have similar dual phase space coordinates. Possible (nearest neighbour) candidate dual phase values for pixels along the epipolar line are shown as stars in the dual space illustration of FIG. 6A. Using these possible matches as context, we are able to derive a sub-pixel estimate of the corresponding location in the right image with closest interpolated dual-space coordinates to the point in the left image (shown by the cross). Using the dual space representation greatly increases the disparity range over which unique matches can be sought thus resolving the phase wrapping problem.

Efficient implementation is achieved by processing corresponding pairs of epipolar lines of the left and right images in turn or in parallel. Corresponding points from the left and right images are limited to lie along these lines reducing the stereo matching problem to a 1-dimensional search. In particular, it is convenient to use camera calibration data to transform the phase images to an equivalent parallel camera geometry where the epipolar lines become horizontal and aligned with the rasters/rows of the image.

As represented in FIG. 6B, for each pair of epipolar lines/image rows, stereo matching proceeds by considering 230 each point in the left row in turn (or in parallel) and searching 240 along the allowed disparity range in the right row (governed by the allowed range of depth in the illuminated object) for the interpolated location with nearest dual phase coordinates. To avoid searching, it is possible to build a spatial index table (or alternatively a K-D Tree) based on dual space coordinates for all the pixels along the right row. Each element in the spatial index stores a list of those pixels that fall within a quantized bin of dual phase values. When searching for nearest neighbours, only a small range of index locations need be considered (taking into account possible wrap around in the phase space for phase values close to the ±π limits). This improves performance greatly.

In an example, an apparatus as described above is used to monitor quality of manufactured products or components within or in association with an additive manufacturing system. The processing unit comprises processing logic for comparing the measured surface features of the illuminated object with surface features in an object description that was used by the additive manufacturing system to manufacture the object, thereby to identify manufacturing errors. In an example apparatus, the processing logic can be used for comparing the identified manufacturing errors with predefined manufacturing tolerance thresholds. In an example, the processing unit includes a control signal generator for generating a signal for controlling the additive manufacturing system in response to identified manufacturing errors—e.g. an in-situ measurement during a manufacturing/printing process which can be used to terminate a current build process. Rapid automated optical scanning can be used to check quality of a first build step before continuing with a second build step. In another example, the reflected images and processing unit are used to evaluate the quality of finished manufactured objects, for quality control and/or recalibrating for a subsequent build. Thus, apparatus and methods as described above can be used to provide automated quality control as well as quality monitoring and calibration.

Although not essential for the sake of measurements, a reconstructed 3D image can be provided based on the above-described dual phase space correspondences, for operator feedback.

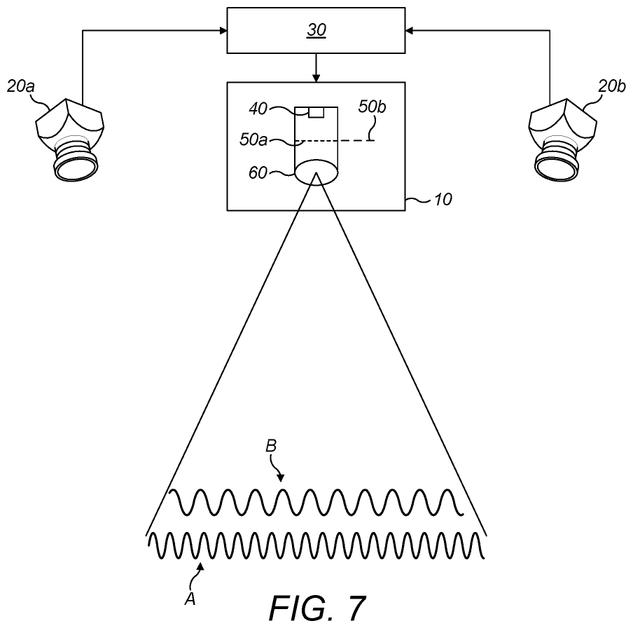

In an example as shown schematically in FIG. 7, a pair of Ronchi gratings 50a, 50b are switchable within a single optical projection assembly, reducing the number of light sources and lens systems compared with the apparatus of FIG. 1. As in the above-described example, the optical projection assembly provides a first light pattern from a first optical grating and light source arrangement (i.e. a grating with a first spatial frequency) and provides a second light pattern from a second optical grating and light source arrangement (i.e. after switching to a grating with a second spatial frequency).

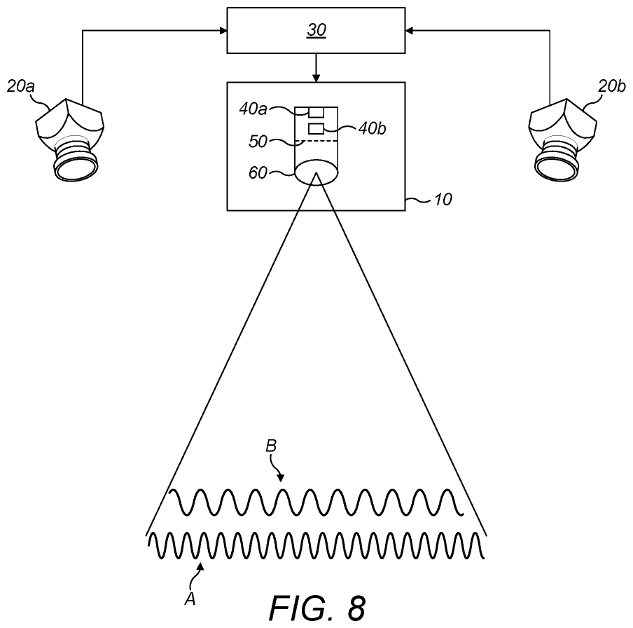

In another example as shown schematically in FIG. 8, a Ronchi grating is illuminated by light sources 40a, 40b located at different distances from the grating 50 and lens system 60, the two light source distances resulting in light patterns with a different spatial frequency from each other. A first light pattern is provided by an optical grating illuminated by a first light source at a first distance from the optical grating and a second light pattern is provided by the same optical grating illuminated by a second light source at a second distance from the optical grating, the second distance being different from the first distance. An apparatus according to this example comprises an optical projection assembly having at least two light sources for the or each optical grating, for illuminating an object with first and second light patterns having different spatial frequencies, wherein the optical projection assembly provides a first light pattern from when the optical grating is illuminated by a first light source and provides a second light pattern when the optical grating is illuminated by the second light source. A pair of cameras capture images corresponding to reflections of the first and second light patterns from the illuminated object, and a processing unit is used to determine depths of surface features of the illuminated object, from the captured reflections of the first and second light patterns. The effects of phase variations in the reflected light patterns correspond to measurable features of the illuminated object.

In an alternative example, the spectral properties of illumination sources (e.g. LEDs) are manipulated to generate the various patterns. The sources are selected to generate light having a wavelength that differs from the ambient light in order that a sensor can filter out unwanted light and maximize the signal-to-noise from the structured patterns. Alternatively, different spectrally non-overlapping narrow band sources could be used for each pattern generator and/or each pattern shift, using an appropriate optical arrangement to split the beam onto distinct sensors or using a single integrated sensor with multiple pixel filters in combination. For example, for a system using 2 pattern projectors each with 3 phase shifts, 6 narrow band LED's could be used to simultaneously capture each phase shift. This would use 6 distinct sensors for each the left and right views, and beam splitting/filtering, but is achievable with no moving parts.

In another example apparatus, the or each optical grating comprises a movable optical grating, for positioning at a plurality of different positions equidistant from the illuminated object, to project a plurality of phase-shifted first light patterns. A plurality of phase-shifted second light patterns is obtained using a second optical grating illuminated by light sources in a plurality of different positions. In an alternative example, a plurality of second light sources is located at a different distance from the optical grating than the first light sources, forming a two dimensional or three dimensional array of light sources for illuminating the or each optical grating, to project a plurality of phase-shifted first light patterns and a plurality of phase-shifted second light patterns. Other examples use a movable light source, for positioning at a plurality of different positions relative to an optical grating, to illuminate the optical grating from different light source positions.

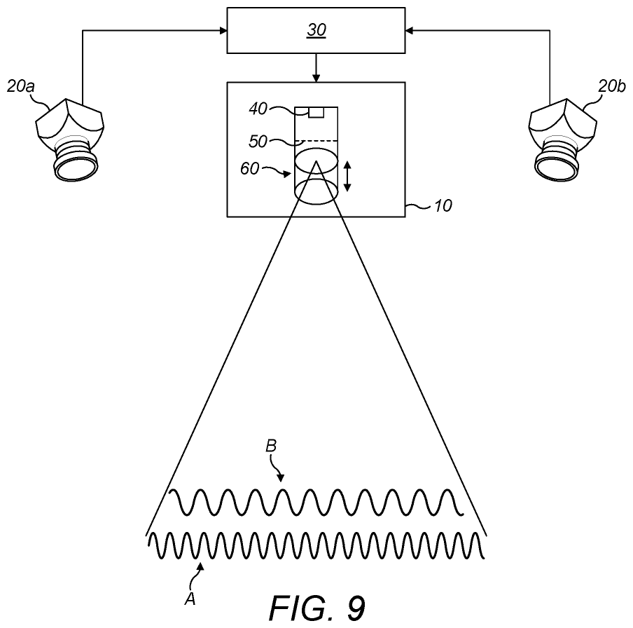

In another example, as shown schematically in FIG. 9, a single projection assembly 10 has a changeable lens system and a single optical grating 50. The optics is a zoom lens 60 and control circuitry to change the magnification while maintaining the same focus (or degree of out of focus). In one example, this system can be switched between a pair of fixed zoom settings 60a, 60b in order to effect magnification of the projected pattern, to change the spatial frequency of the approximated sine wave. In this example, the same grating and light source can be used with the changeable lens to produce light patterns with different spatial frequencies.

In an apparatus according to an example, the or each optical projection assembly comprises a plurality of optical gratings that have different respective spacing between their optical transmission features, to generate the first and second light patterns having different spatial frequencies when the plurality of optical gratings are illuminated by at least one light source. By illuminating each grating from multiple light source positions, a set of phase-shifted patterns of each spatial frequency can be captured and processed to determine depths of features in the surface of an illuminated object.

An example apparatus includes an additive manufacturing system, comprising: apparatus for additive manufacturing of objects; and apparatus for detecting surface features of a manufactured object, wherein the apparatus for detecting surface features comprises: at least one optical projection assembly for illuminating an object with first and second light patterns having different spatial frequencies; at least one image capturing device, for capturing images corresponding to reflections of the first and second light patterns from the illuminated object; and a processing unit for identifying, from the captured reflections of the first and second light patterns, the effects of phase variations in the reflected light patterns corresponding to surface features of the illuminated object.

In an example apparatus as described above, the processing unit comprises processing logic for comparing the surface features of the illuminated object with surface features in an object description that was used by the additive manufacturing system to manufacture the object, thereby to identify manufacturing errors. In an example, the processing unit further comprises processing logic for comparing the identified manufacturing errors with predefined manufacturing tolerance thresholds. In an example, the processing unit further comprises a control signal generator for generating a signal for controlling the additive manufacturing system in response to identified manufacturing errors.

1. An apparatus comprising:
an optical projection assembly comprising a light source and an optical grating, for illuminating an object with first and second light patterns having different spatial frequencies, wherein the optical projection assembly provides a first light pattern in a first configuration of the optical projection assembly and provides a second light pattern in a second configuration of the optical projection assembly;
an image capturing apparatus to capture images corresponding to reflections of the first and second light patterns from the illuminated object; and
a processing unit to identify, from the captured reflections of the first and second light patterns, the effects of phase variations in the reflected light patterns corresponding to features of the illuminated object.

2. An apparatus according to claim 1, wherein the first and second light patterns are provided by a plurality of optical gratings having different spatial frequencies.

3. An apparatus according to claim 2, wherein the optical projection assembly comprises an optical grating for optical alignment with light sources at a plurality of different positions equidistant from the first optical grating, to project a plurality of phase-shifted first light patterns.

4. An apparatus according to claim 2, wherein the optical projection assembly comprises an optical grating that is movable between a plurality of different positions equidistant from the illuminated object, to project a plurality of phase-shifted first light patterns.

5. An apparatus according to claim 2, wherein the optical projection assembly comprises a first optical grating and a movable light source for movement between a plurality of different positions equidistant from the first optical grating, to project a plurality of phase-shifted first light patterns.

6. An apparatus according to claim 1, wherein the first light pattern is provided by an optical grating in a first optical projection assembly configuration and the second light pattern is provided by the same optical grating in an altered optical projection assembly configuration.

7. An apparatus according to claim 1, wherein the first configuration of the optical projection assembly comprises a light source at a first distance from an optical grating and the second configuration of the optical projection assembly comprises a light source at a second distance from the optical grating, the first distance being different from the second distance.

8. An apparatus according to claim 1, wherein the optical grating comprises a constant interval binary mask, and the optical projection assembly further comprises a defocussing element in optical alignment with the optical grating, to generate a periodic light pattern with continuous light intensity variation when the optical grating is illuminated by a light source.

9. An apparatus according to claim 8, wherein the optical grating comprises a square wave Ronchi grating, and the defocussing element is arranged to modify the projected square wave pattern to approximate a sine wave pattern.

10. An apparatus according to claim 1, wherein the image capturing apparatus comprises at least first and second cameras and wherein the processing unit includes processing logic for determining depth of features of the illuminated object from phase variations in the reflected light patterns captured by the first and second cameras.

11. An apparatus according to claim 1, for quality monitoring within an additive manufacturing system, wherein the processing unit comprises processing logic for comparing the identified features of the illuminated object with corresponding features in an object description used by the additive manufacturing system to manufacture the object, thereby to identify manufacturing errors.

12. An apparatus according to claim 10, wherein the processing unit further comprises a control signal generator for generating a signal for controlling the additive manufacturing system in response to identified manufacturing errors.

13. An additive manufacturing system, comprising:
apparatus to additively manufacture objects; and
apparatus to identify features of a manufactured object, wherein the apparatus comprises:
an optical projection assembly comprising a light source and an optical grating to illuminate an object with first and second light patterns having different spatial frequencies, wherein the optical projection assembly provides a first light pattern from a first configuration of the optical projection assembly and provides a second light pattern from a second configuration of the optical projection assembly;
an image capturing apparatus to capture images corresponding to reflections of the first and second light patterns from the illuminated object; and
a processing unit to identify, from the captured reflections of the first and second light patterns, the effects of phase variations in the reflected light patterns corresponding to features of the illuminated object.

14. An apparatus according to claim 12, wherein the processing unit comprises processing logic to compare the surface features of the illuminated object with surface features in an object description that was used by the additive manufacturing system to manufacture the object, thereby to identify manufacturing errors; and optionally wherein the processing unit further comprises a control signal generator to generate a signal for controlling the additive manufacturing system in response to identified manufacturing errors.

15. A method for determining depths of features of a three dimensional object, comprising:
using an optical projection assembly comprising a light source and an optical grating to illuminate an object with first and second light patterns having different spatial frequencies corresponding to first and second configurations of the optical projection assembly;
using first and second cameras to capture images corresponding to reflections of the first and second light patterns from the illuminated object; and
determining, from phase information in the reflections of the first and second light patterns captured by the first and second cameras, depths of features of the illuminated object.
